(19) United States
(12) Patent Application Publication
(10) Pub. No.: US 2021/0349332 A1
(43) Pub. Date: Nov. 11, 2021

(54) EYEGLASSES ASSEMBLY WITH REMOVABLE LENS

(71) Applicant: York TSAI, New Taipei City (TW)

(72) Inventor: York TSAI, New Taipei City (TW)

(21) Appl. No.: 17/307,623

(22) Filed: May 4, 2021

(30) Foreign Application Priority Data
May 5, 2020 (TW) 109205380

(51) Int. Cl. G02C 1/00; G02C 1/02; G02C 5/02

(52) U.S. Cl. CPC G02C 1/10; G02C 2200/08; G02C 5/02; G02C 1/023

(57) ABSTRACT

An eyeglasses assembly includes a frame and a lens. The frame includes a frame body formed with a frame groove and two engaging grooves, and a positioning column disposed in the frame groove. The lens has a main portion formed with a lens groove and a securing groove that extends perpendicularly from the lens groove. The lens further has first and second protruding portions engaging removably and respectively with the engaging grooves. The lens is movable between an initial position, where the positioning column is disposed at an intersection of the lens groove and the securing groove, and a fixed position, where the positioning column is disposed at a distal end of the securing groove such that the second protruding portion is allowed to be disengaged from the respective engaging groove.

### CROSS-REFERENCE TO RELATED APPLICATION

This application claims priority to Taiwanese Utility Model Patent Application No. 109205380, filed on May 5, 2020.

### FIELD

The disclosure relates to an eyeglasses assembly, and more particularly to an eyeglasses assembly with removable lens.

### BACKGROUND

FIGS. 1 and 2 show conventional eyeglasses with removable lens disclosed in U.S. Patent Application Publication No. 20170100287A1. The conventional eyeglasses include a frame 11, two temples 12 respectively connected to opposite ends of the frame 11 as pivot connections, and a lens 13 removably connected to the frame 11. The frame 11 includes a first securing member 111 disposed centrally on a top end of the frame 11, a second securing member 112 connected between a lateral end of the frame 11 and one of the respective temples 12, and a third securing member 113 connected between an opposite lateral end of the frame 11 and the other one of the respective temples 12. The third securing member 113 has a pivot section 114 that is pivotable relative to the first securing member 111, a securing section 115 that protrudes from the pivot section 114, an affixing channel 116 that is engageable with the securing section 115, and an engaging section 117 that is adjacent to the affixing channel 116. The lens 13 includes a lens body 131, and a first protrusion 132 extending obliquely from a top end of the lens body 131 and disposed for engaging with the first securing member 111. The lens 13 further includes a second protrusion 133 extending from one of opposite elongated ends of the lens body 131, and a third protrusion 134 extending from the other of the opposite elongated ends of the lens body 131. The second protrusion 133 and the third protrusion 134 respectively engage with the second securing member 112 and third securing member 113. Additionally, the third protrusion 134 has a shape that matches the engaging section 117 of the third securing member 113.

Referring to FIGS. 2 and 3, the conventional eyeglasses are assembled by rotating the pivot section 114 away from the engaging section 117, thereby exposing the engaging section 117 and the affixing channel 116. Next, the first protrusion 132 and the second protrusion 133 of the lens 13 are respectively engaged with the first securing member 111 and the second securing member 112 of the frame 11 while the third protrusion 134 is positioned in the engaging section 117. The pivot section 114 is then rotated to a position where the securing section 115 engages with the affixing channel 116 and the third protrusion 134 is stably affixed between the pivot section 114 and the engaging section 117. By virtue of the engaging section 117 and the pivot section 114 stably affixing the third protrusion 134 in the third securing member 113, the lens 13 is stably secured to the frame 11 of the conventional eyeglasses and will not fall off. The first protrusion 132 and the second protrusion 133 respectively engaging with the first securing member 111 and the second securing member 112 adds additional stability to the lens 13.

However, the third securing member 113 of the conventional eyeglasses has a complex and fragile structure that is costly to manufacture. Moreover, if the third securing member 113 is damaged by impact or collision with an external force, the securing section 115 may not be able to stably engage with the affixing channel 116, which will cause the pivot section 114 to be unable to stably affix the third protrusion 134. Additionally, the first securing member 111 and the second securing member 112 are loosely engaged with the first protrusion 132 and the second protrusion 133 of the lens 13, so that the lens 13 cannot be secured to the frame 11 with these engagements alone without the engagement between the third securing member 113 and the third protrusion 134 of the lens 13. In other words, the lens 13 may not be secured to the frame 11 if the third securing member 113 of the frame 11 is damaged.

### SUMMARY

Therefore, an object of this disclosure is to provide an eyeglasses assembly that has a simple structure, that is economic to manufacture, and that is durable and unlikely to be damaged from impact.

According to the disclosure, an eyeglasses assembly includes a frame, an attachment unit, and a lens. The frame includes a frame body and a positioning column. The frame body is formed with a frame groove that has an opening facing downwards and that is elongated along the frame body between left and right end portions of the frame body, and two engaging grooves that are respectively disposed at the left and right end portions of the frame body. The positioning column is disposed in the frame groove and extends in a front-rear direction. The attachment unit is connected to opposite ends of the frame and is adapted to secure the frame to a user's face. The lens has a main portion that removably engages with the frame groove of the frame body of the frame, and that is formed with a lens groove extending downwards from a top end of the main portion. The main portion is further formed with a securing groove that extends perpendicularly from the lens groove. The lens further has a protruding portion extending from the main portion and engaging removably with one of the engaging grooves, and a second protruding portion opposite to the first protruding portion, extending from the main portion, and engaging removably with the other one of the engaging grooves. The securing groove extends from the lens groove towards the second protruding portion.

The lens is movable relative to the frame between an initial position, where the positioning column is disposed at an intersection of the lens groove and the securing groove, and a fixed position, where the positioning column is disposed at an end of the securing groove which is distal from the lens groove such that the second protruding portion of the lens is allowed to be disengaged from the other one of the engaging grooves.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating conventional eyeglasses;

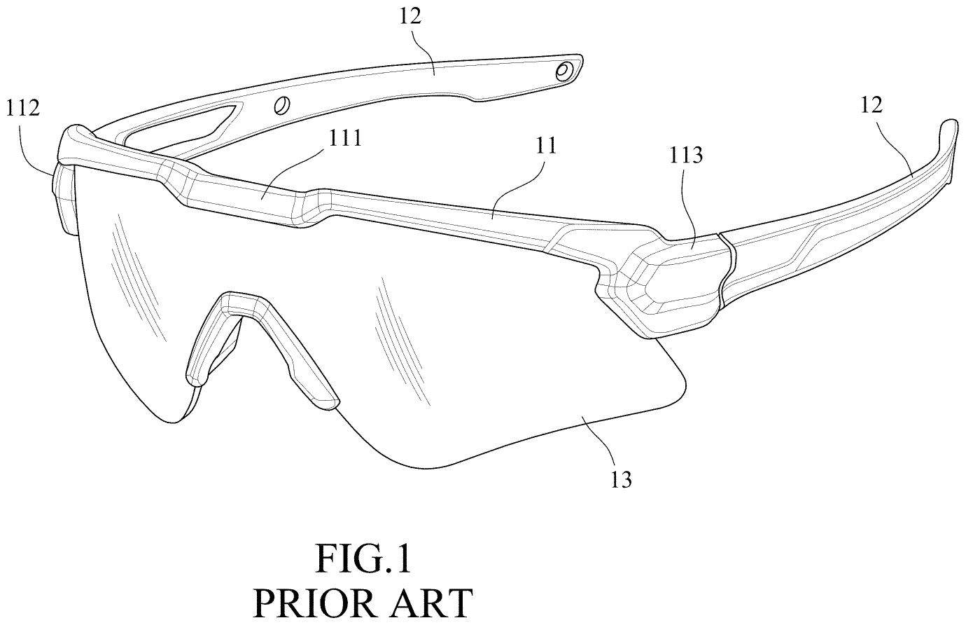

FIG. 2 is a perspective view illustrating assembly of the conventional eyeglasses;

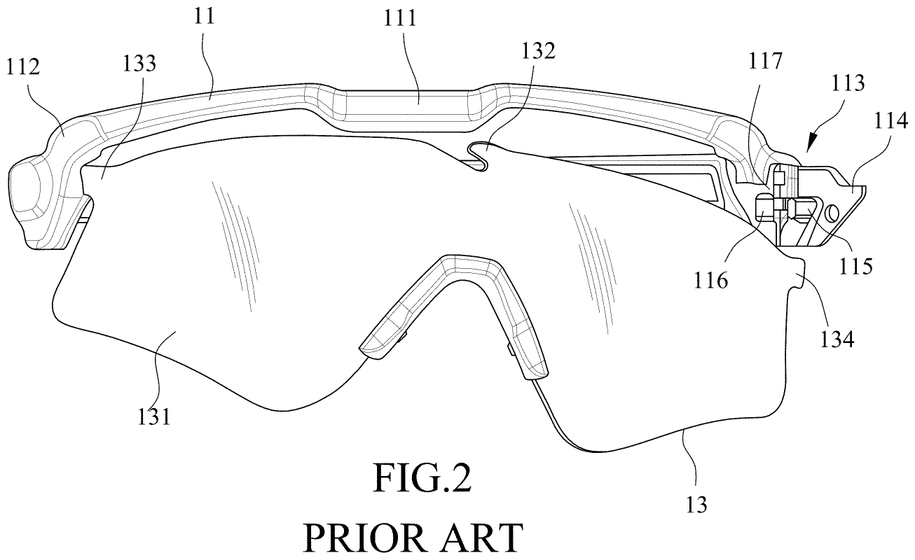

FIG. 3 is a fragmentary perspective view illustrating the assembly of the conventional eyeglasses;

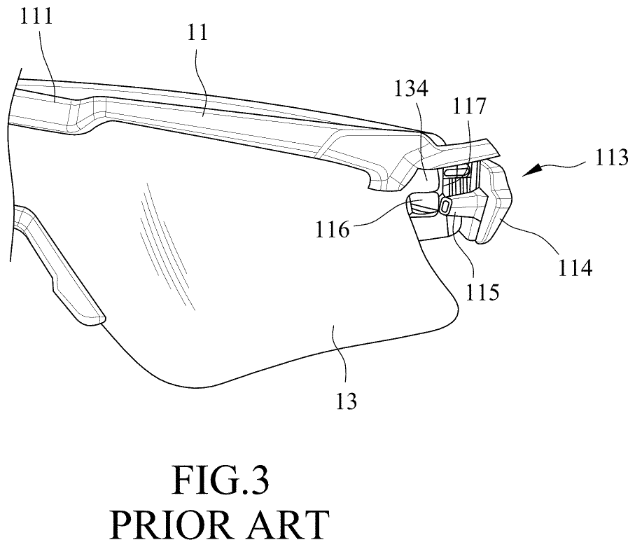

FIG. 4 is a perspective view illustrating an embodiment of the eyeglasses assembly of this disclosure;

FIG. 5 is a fragmentary exploded perspective view illustrating the embodiment;

FIG. 6 is an exploded front view of the embodiment;

FIG. 7 is a front view of the embodiment, illustrating a lens at an initial position and a second protruding portion of the lens not engaged with an engaging groove of a frame;

FIG. 8 is a view similar to FIG. 7, but illustrating the lens at a fixed position; and

FIG. 9 is a view similar to FIG. 7, but illustrating the lens being fully assembled to the frame.

### DETAILED DESCRIPTION

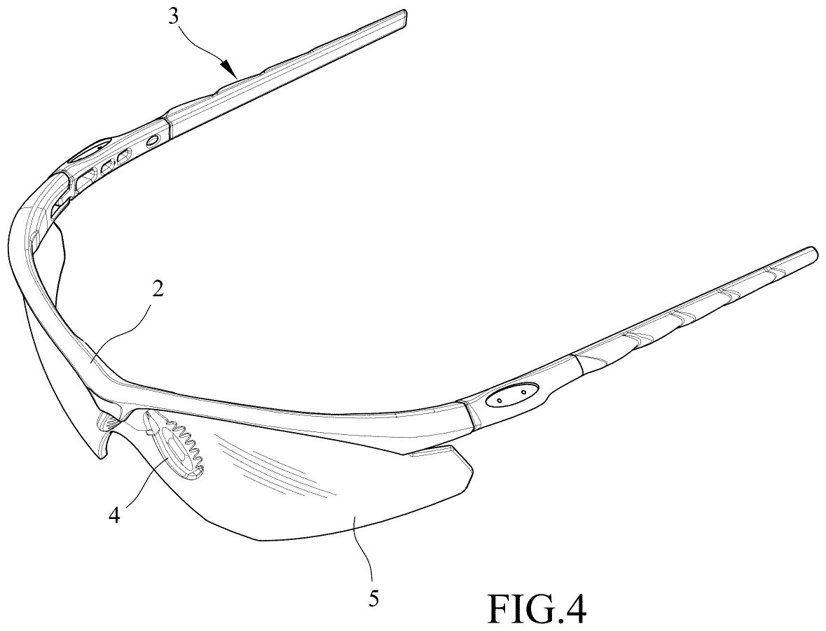

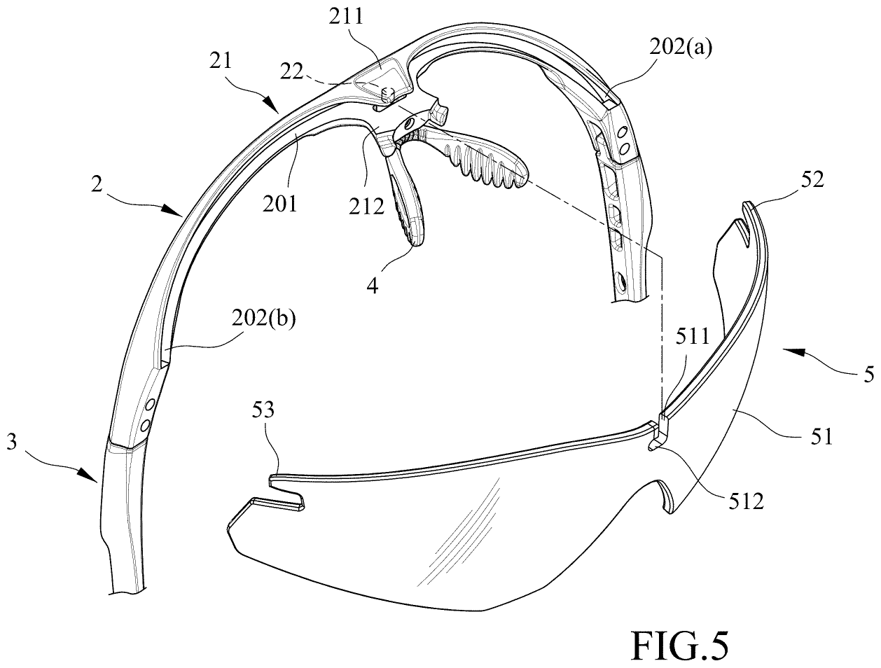

FIGS. 4 and 5 show an embodiment of an eyeglasses assembly according to the present disclosure. The eyeglasses assembly includes a frame 2, an attachment unit 3 that is connected to opposite ends of the frame 2, a nose pad 4 that is connected to the frame 2, and a lens 5 that is removably connected to the frame 2. A reference direction where a wearer of the eyeglasses assembly is defined as being in a rearward position relative to the eyeglasses assembly is used throughout this disclosure.

The frame 2 of the eyeglasses assembly includes a frame body 21 formed with a frame groove 201. The frame groove 201 has an opening facing downwards and is elongated along the frame body 21 between left and right end portions of the frame body 21. The frame body 21 is further formed with two engaging grooves 202(a), 202(b) that are respectively disposed on the left and right end portions of the frame body 21. The frame 2 further includes a positioning column 22 disposed in the frame groove 201 and extending in a front-rear direction. The frame body 21 includes a front wall 211, and a back wall 212 opposite to the front wall 211 in the front-rear direction. The front wall 211 cooperates with the back wall 212 to define the frame groove 201. In the present embodiment, the positioning column 22 is perpendicular to the front wall 211 and the back wall 212, and the frame body 21 and the positioning column 22 are integrally formed as one piece. However, in other embodiments the positioning column 22 may not be perpendicular to the front wall 211 and the back wall 212, and the frame 2 may not be integrally formed as one piece, instead, the frame body 21 and the positioning column 22 may be formed as separate pieces.

It should be mentioned that when the frame body 21 and the positioning column 22 are integrally formed as one piece, the overall structural strength of the frame 2 will be increased which not only lowers the probability of the frame 2 being damaged from impact, but also decreases the amount of raw materials required to manufacture the frame 2, thereby lowering the cost of manufacture.

In the present embodiment, the attachment unit 3 is substantiated by two temples respectively connected to two opposite elongated ends of the frame 2 via pivot connections (as shown in FIG. 4), and are used to secure the frame 2 to a user's face. However, in other embodiments of the eyeglasses assembly, the attachment unit 3 may be made of a strap similar to the attachments on conventional safety glasses, or elastic headbands similar to the attachments on conventional swimming goggles; the eyeglasses assembly may have any type of attachment that can secure the frame 2 to the user's face.

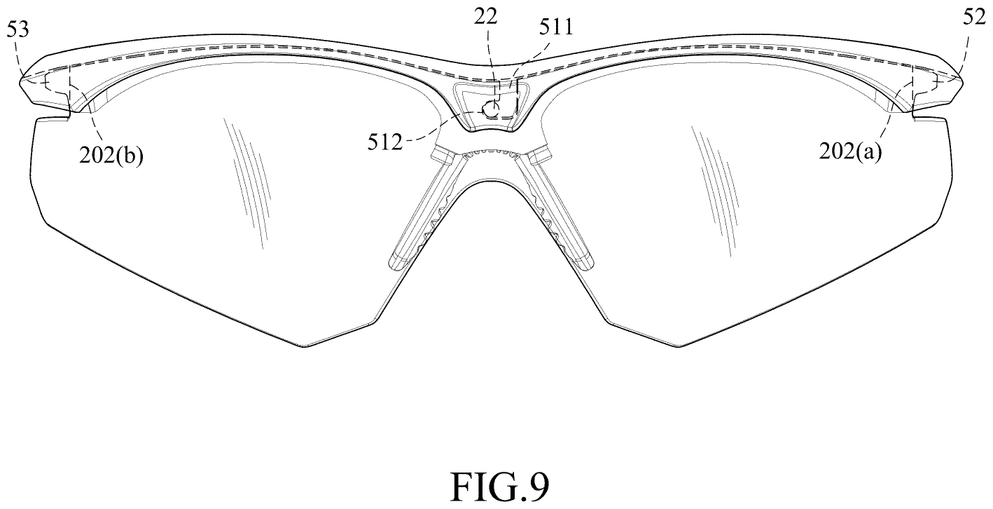

Referring to FIGS. 4 and 5, the width of the frame groove 201 between the front and back walls 211, 212 is matched to thickness of the lens 5, and the shape of the lens 5 follows frontal curvature of the frame body 21. The lens 5 has a main portion 51 engaging removably with the frame groove 201 of the frame body 21 of the frame 2. The main portion 51 is formed with a lens groove 511 that extends downwards from a top end of the main portion 51, and a securing groove 512 that extends perpendicularly from the lens groove 511. Referring further to FIG. 9, the lens 5 further has a first protruding portion 52 extending from the main portion 51 and engaging removably with the engaging groove 202(a), and a second protruding portion 53 opposite to the first protruding portion 52, extending from the main portion 51 and engaging removably with the engaging groove 202(b). In the present embodiment, the securing groove 512 extends from the lens groove 511 toward the second protruding portion 53, and the shape of the securing groove 512 at a distal end away from the lens groove 511 matches a contour of the positioning column 22 when viewed frontally.

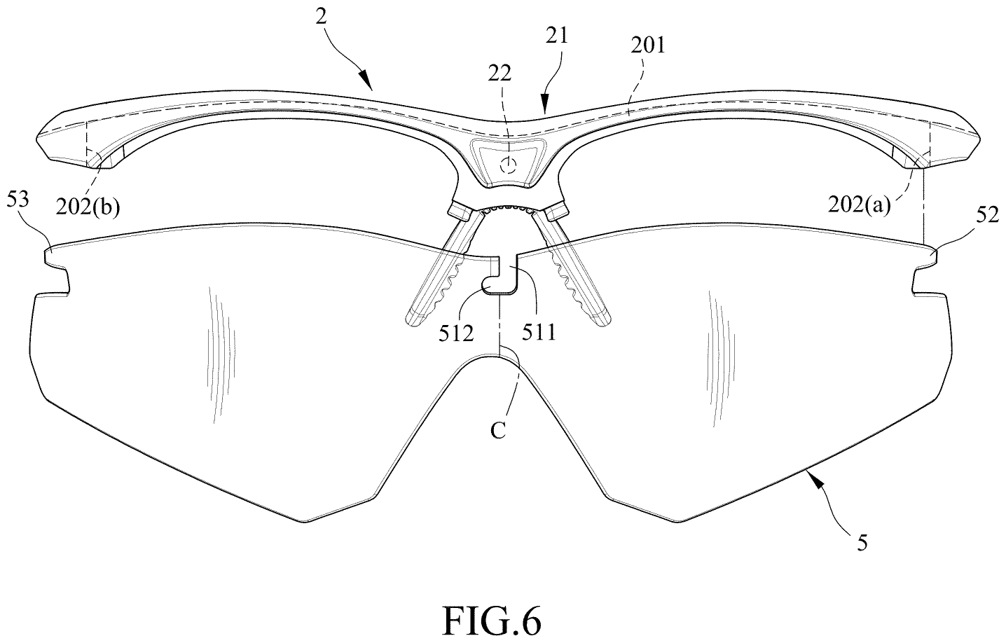

In the present embodiment, referring further to FIG. 6, the first protruding portion 52 and the second protruding portion 53 of the lens 5 have reflection symmetry about a centerline (C) of the lens 5, and the first protruding portion 52 and the second protruding portion 53 are on transversely-opposite sides of the main portion 51 with respect to the centerline (C). The lens 5 is therefore structurally balanced and proportioned symmetrically.

In the present embodiment, the nose pad 4 is connected to the frame 2 in the center of the back wall 212, where it assists the attachment unit 3 in securing the frame 2 to the user's nose. The nose pad 4 can be adjusted according to requirements of the user. Therefore, in other embodiments, the nose pad 4 may be connected to the main portion 51 of the lens 5, where it will become removable from the frame 2 along with the lens 5. It should be noted that location of the nose pad 4 on the eyeglasses assembly should not be limited to the positions discussed above, and the nose pad 4 may be attached on any position suitable for securing the eyeglasses assembly to the user's face.

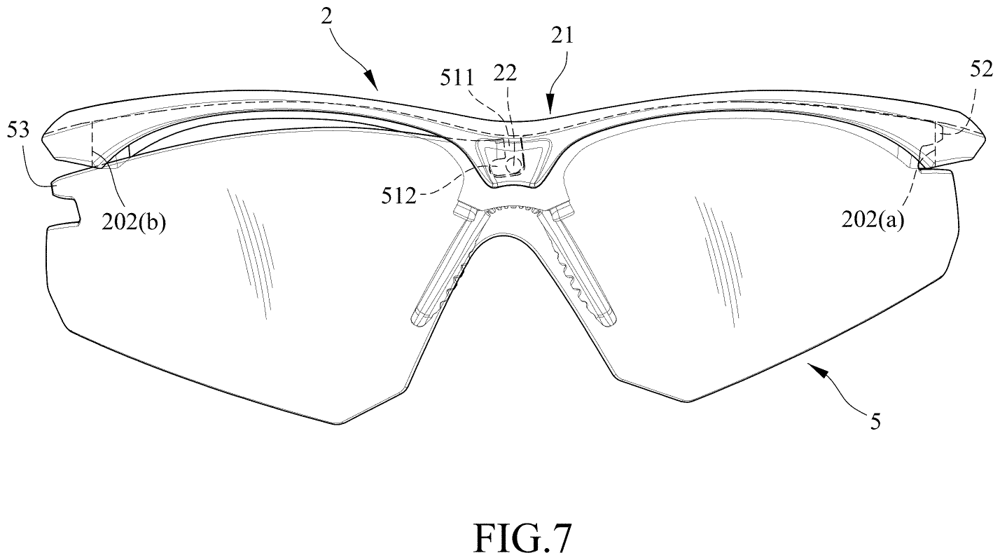

FIG. 6 shows an embodiment of the eyeglasses assembly at the start of an assembly procedure. As shown in FIG. 7, when assembling the lens 5 to the frame 2, the user inserts the first protruding portion 52 into the engaging groove 202(a) so as to engage the first protruding portion 52 with the engaging groove 202(a), and at the same time moves the positioning column 22 into the lens groove 511 via an open end of the lens groove 511 at the top end of the main portion 51 of the lens 5. The lens 5 is then pushed into the frame groove 201 to engage with the frame groove 201 until the lens 5 is moved to an initial position, where the positioning column 22 reaches an intersection of the lens groove 511 and the securing groove 512, as shown in FIG. 7.

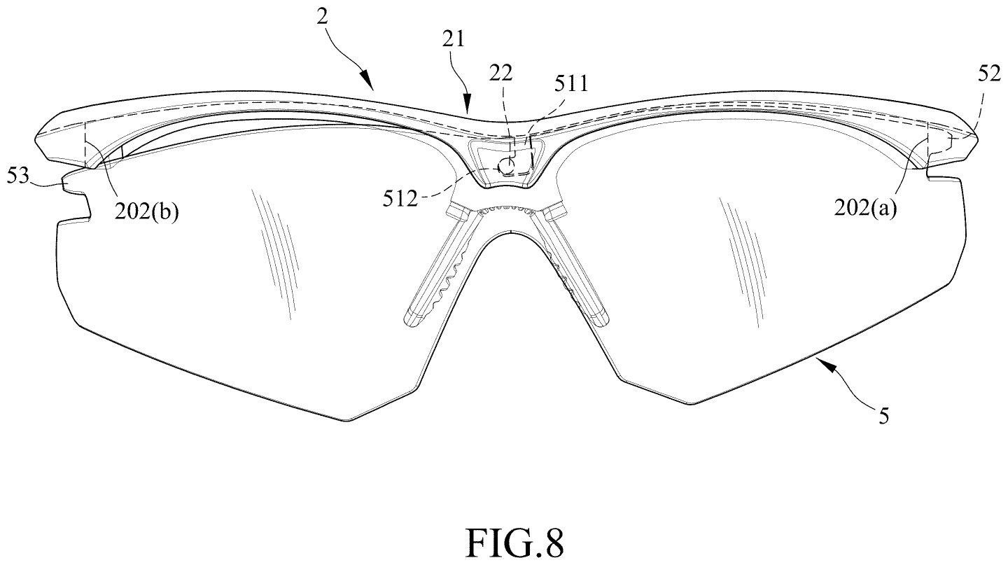

The lens 5 can then be pushed transversely relative to the frame 2 from the initial position to a fixed position as shown in FIG. 8.

When the lens 5 is in the initial position, the second protruding portion 53 is not allowed to be engaged with the engaging groove 202(b). When the lens 5 is pushed to the fixed position, the centerline (C) of the lens 5 is shifted to be closer to the engaging groove 202(a), and the second protruding portion 53 is more proximate to the engaging groove 202(b) than in the initial position. At this time, the second protruding portion 53 of the lens 5 is allowed to be engaged with the engaging groove 202 (b).

Additionally, due to the shape of the distal end of the securing groove 512 matching the contour of the positioning column 22 when viewed from the front of the eyeglasses assembly, the lens 5 can be securely attached on the frame 2. Finally, to complete the assembly of the eyeglasses assembly the lens 5 is pushed so that the second protruding portion 53 engages with the other one of the engaging grooves 202(b), and the lens 5 is securely attached to the frame 2 as shown in FIG. 9.

For disassembly of the present embodiment of the eyeglasses assembly, the assembly procedure is performed in reverse order. First, since the lens 5 is at the fixed position, the second protruding portion 53 is allowed to be disengaged from the engaging groove 202(b), so that the user can pull the lens 5 to release the second protruding portion 53 from engagement with the engaging groove 202(b) to the state shown in FIG. 8. Then, the lens 5 is pushed transversely relative to the frame 2 to return to the initial position. Finally, the first protruding portion 52 is released from engagement with the engaging groove 202(a) to separate the lens 5 from the frame 2 and the eyeglasses assembly is disassembled.

It should be noted that in a variation of this embodiment, the first protruding portion 52 and the second protruding portion 53 can be made smaller. In such a case the eyeglasses assembly is assembled by first moving the positioning column 22 via the lens groove 511 to the intersection of the lens groove 511 and the securing groove 512, and then pushing the lens 5 so that the first protruding portion 52 is inserted into and engages with the engaging groove 202 (a). The remaining steps in the assembly procedure are the same as that of the previously described embodiment. The securing groove 512 being designed to be perpendicular to the lens groove 511 facilitates engagement between the first and second protruding portions 52, 53 and the engaging grooves 202(a), 202(b) of the frame 2. Additionally, the design of the securing groove 512 and the lens groove 511 provides a confining mechanism that stabilizes the device and ensures that the positioning column 22 is confined within the securing groove 512, thereby preventing the lens 5 from separating from the frame 2.

In another variation of this embodiment, the lens groove 511 may be formed on the centerline (C) of the lens 5. The assembly procedure for such variation is performed by engaging the positioning column 22 with the lens groove 511 and the securing groove 512 disposing the lens 5 at the initial position. The lens 5 is then pushed from the initial position to the fixed position. At this time, the second protruding portion 53 is proximate to the engaging groove 202(b) and the lens 5 can be pushed to engage the second protruding portion 53 with the engaging groove 202 (b). The lens 5 is then pushed once again to the initial position to move the first protruding portion 52 to be proximate to the engaging groove 202(a). The lens 5 can then be pushed to engage the first protruding portion 52 with the engaging groove 202(a) to thereby complete the assembly of such variation. The different assembly procedures described above show the cooperation of different components of the eyeglasses assembly, and describe how different assembly procedures may be taken to perform the assembly of the eyeglasses assembly. Flexibility of the eyeglasses assembly's assembly procedure allows the components of the eyeglasses assembly to be more diverse. For example, in some embodiments of the eyeglasses assembly, the lens groove 511 and the securing groove 512 may be formed at different locations or the first protruding portion 52 and the second protruding portion 53 can be made in different sizes and shapes or disposed on different locations of the eyeglasses assembly.

In summary, the eyeglasses assembly with removable lens has various straightforward assembling procedures where the positioning column 22 is movable within the lens groove 511 and the securing groove 512, that are designed to be substantially perpendicular to each other. The first protruding portion 52 and the second protruding portion 53 can respectively engage with the engaging grooves 202(a), 202(b) so that the lens 5 is securely attached to the frame 2. Additionally, due to the frame body 21 and positioning column 22 being integrally formed in one piece (in some embodiments of the eyeglasses assembly), the eyeglasses assembly is less costly to manufacture and structurally more sturdy. Because of the increase sturdiness, the probability of damaging the eyeglasses assembly from collision or impact with an external force is reduced.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An eyeglasses assembly comprising:
a frame that includes
a frame body formed with
a frame groove that has an opening facing downwards and that is elongated along said frame body between left and right end portions of said frame body, and
two engaging grooves that are respectively disposed at said left and right end portions of said frame body, and
a positioning column disposed in said frame groove and extending in a front-rear direction;
an attachment unit that is connected to opposite ends of said frame and that is adapted to secure said frame to a user's face; and
a lens that has
a main portion engaging removably with said frame groove of said frame body of said frame, and formed with
a lens groove that extends downwards from a top end of said main portion, and
a securing groove that extends perpendicularly from said lens groove,
a first protruding portion extending from said main portion and engaging removably with one of said engaging grooves, and
a second protruding portion opposite to said first protruding portion, extending from said main portion, and engaging removably with the other one of said engaging grooves, said securing groove extending from said lens groove toward said second protruding portion;
wherein said lens is movable relative to said frame between an initial position, where said positioning column is disposed at an intersection of said lens groove and said securing groove, and a fixed position, where said positioning column is disposed at an end of said securing groove which is distal from said lens groove such that said second protruding portion of said lens is allowed to be disengaged from said other one of said engaging grooves.

2. The eyeglasses assembly as claimed in claim 1, wherein:
said frame body includes
a front wall, and
a back wall opposite to said front wall in the front-rear direction, and cooperating with said back wall to define said frame groove; and
said positioning column is perpendicular to said front wall and said back wall.

3. The eyeglasses assembly as claimed in claim 1, wherein, said frame body and said positioning column are integrally formed as one piece.

4. The eyeglasses assembly as claimed in claim 3, further comprising a nose pad that is connected to said frame.

5. The eyeglasses assembly as claimed in claim 3, further comprising a nose pad that is connected to said lens.

6. The eyeglasses assembly as claimed in claim 2, further comprising a nose pad that is connected to said frame.

7. The eyeglasses assembly as claimed in claim 2, further comprising a nose pad that is connected to said lens.

8. The eyeglasses assembly as claimed in claim 1, further comprising a nose pad that is connected to said frame.

9. The eyeglasses assembly as claimed in claim 1, further comprising a nose pad that is connected to said lens.
